(19) United States
(12) Patent Application Publication
(10) Pub. No.: US 2015/0134820 A1
(43) Pub. Date: May 14, 2015

(54) INFORMATION PROCESSING APPARATUS, CONTROL METHOD AND STORAGE MEDIUM

(71) Applicant: Kabushiki Kaisha Toshiba, Tokyo (JP)

(72) Inventor: Tetsuo Hatakeyama, Tachikawa-shi (JP)

(21) Appl. No.: 14/456,741

(22) Filed: Aug. 11, 2014

(30) Foreign Application Priority Data
Nov. 8, 2013 (JP) 2013-232265

(51) Int. Cl. H04W 12/08; H04L 29/06

(52) U.S. Cl. CPC H04W 12/08; H04L 63/10
USPC 709/225

(57) ABSTRACT

According to one embodiment, an information processing apparatus with a multiuser function includes first, second and third controllers. The first controller disconnects a first network when a basic user or an additional user is selected, and disconnects a second network when a specific additional user is selected. The second controller terminates an application program of the specific additional user when the basic user or the additional user is selected, and terminates an application program of the additional user when the specific additional user is selected. The third controller restricts network use by an application program of the basic user when the specific additional user is selected.

### CROSS-REFERENCE TO RELATED APPLICATIONS

This application is based upon and claims the benefit of priority from Japanese Patent Application No. 2013-232265, filed Nov. 8, 2013, the entire contents of which are incorporated herein by reference.

### FIELD

Embodiments described herein relate generally to a control technique suitable for, for example, an information processing apparatus including a multiuser function.

### BACKGROUND

In recent years, portable, battery-driven information processing apparatuses such as notebook personal computers (PC) and tablet computers, have become widespread. Many such information processing apparatuses include a multiuser function which enables a plurality of users to use a single information processing apparatus in their own respective operating environments.

In addition, the multiuser function is often used by single users to work in a plurality of operating environments.

Recently, companies have begun to allow employees to use their own information processing apparatuses (including those provided by the companies) in the office for business (so-called Bring Your Own Device [BYOD] schemes). To make BYOD possible, it is necessary to implement appropriate security measures with regard to brought information processing apparatuses.

As described above, many information processing apparatuses have a multiuser function. Thus, it is also conceivable to realize the BYOD while implementing security measures by using an operating environment intended for use in an office and an operating environment intended for use outside the office separately by means of the multiuser function.

It should be noted that the multiuser function generally enables use by a plurality of users by setting one or more additional users in addition to a basic user. In other words, in an information processing apparatus including the multiuser function, it is premised that, at a minimum, a basic user exists, and if an application program, etc., of the basic user is terminated, operation of the information processing apparatus may not be guaranteed. Thus, in the case of realizing the BYOD for which security measures are implemented by using the multiuser function, it is impractical to adopt a simple method in which when a certain user (for example, an additional user) starts use, application programs of all other users (for example, a basic user and another additional user) are terminated and their activation is restricted. Therefore, for example, by such a simple method of terminating application programs (including an application program using a network) of all users other than the user that has started use, and restricting their activation, permission and prohibition of connection to respective networks cannot be controlled for individual users (including a basic user).

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outside of an information processing apparatus according to an embodiment.

FIG. 2 is an exemplary view showing a pattern of use of the information processing apparatus according to the embodiment.

FIG. 3 is an exemplary view showing a system configuration of the information processing apparatus according to the embodiment.

FIG. 4 is an exemplary view showing a login screen displayed by the information processing apparatus according to the embodiment.

FIG. 5 is an exemplary view showing a functional block associated with network connection control of the information processing apparatus according to the embodiment.

FIG. 6 is an exemplary view showing an example of a structure of network connection control information used by the information processing apparatus according to the embodiment.

FIG. 7 is an exemplary view showing an outline of network connection control by the information processing apparatus according to the embodiment.

FIG. 8 is an exemplary first flowchart showing a procedure of network connection control executed by the information processing apparatus according to the embodiment.

FIG. 9 is an exemplary second flowchart showing a procedure of network connection control executed by the information processing apparatus according to the embodiment.

FIG. 10 is an exemplary third flowchart showing a procedure of network connection control executed by the information processing apparatus according to the embodiment.

### DETAILED DESCRIPTION

Various embodiments will be described hereinafter with reference to the accompanying drawings.

In general, according to one embodiment, an information processing apparatus is capable of a multiuser function. The apparatus includes a user selection processor, a network connection processor, an application processor, a first multiuser-adaptive controller, a second multiuser-adaptive controller, and a third multiuser-adaptive controller. The user selection processor is configured to select one of a first user, a second user and a third user. The first user represents a basic user. The second user represents a specific additional user. The third user represents an additional user other than the specific additional user. The network connection processor is configured to connect to a network including a first network which the second user is permitted to use. The application processor is configured to activate, terminate, restrict activation of, and restrict network use by, an application program. The first multiuser-adaptive controller is configured to control the network connection processor to disconnect the first network when the first user or the third user is selected, and to disconnect a second network other than the first network when the second user is selected. The second multiuser-adaptive controller is configured to control the application processor to terminate a second application program of the second user or restrict activation of the second application program when the first user or the third user is selected, and to terminate a third application program of the third user or restrict activation of the third application program when the second user is selected. The third multiuser-adaptive controller is configured to control the application processor to restrict network use by a first application program of the first user when the second user is selected.

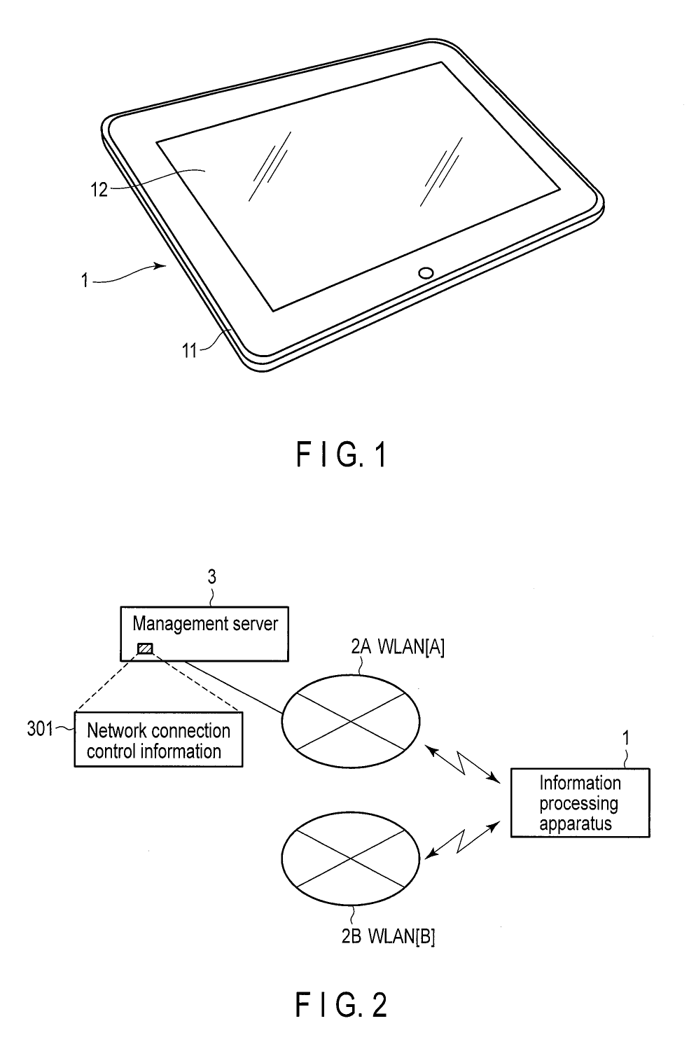

An information processing apparatus according to the embodiment can be implemented as, for example, a notebook PC or a tablet computer including a multiuser function. FIG. 1 is an exemplary perspective view showing the outside of the information processing apparatus according to the embodiment. As shown in FIG. 1, here, it is assumed that the information processing apparatus according to the embodiment is implemented as a tablet computer 1. The tablet computer 1 includes a main body 11 and a touchscreen display 12.

The main body 11 has a housing shaped like a thin box. A flat panel display and a sensor configured to detect a touch position of a finger, a pen or the like on the screen of the flat panel display are incorporated in the touchscreen display 12. The flat panel display is, for example, a liquid crystal display (LCD). The sensor is, for example, a capacitive touchpanel. The touchpanel is provided to cover the screen of the flat panel display.

FIG. 2 is an exemplary view showing a pattern of use of the tablet computer 1.

The tablet computer 1 is an information processing apparatus available for a BYOD scheme which is used for business in an office and is used for personal use outside the office, for example, at home. The tablet computer 1 includes a wireless communication function. In FIG. 2, a wireless LAN[A] 2A is, for example, a corporate intranet, and a wireless LAN[B] 2B is, for example, a home network for Internet connection. The tablet computer 1 can connect to both wireless LAN[A] 2A and wireless LAN[B] 2B.

As described above, the tablet computer 1 includes a multiuser function. The tablet computer 1 uses operating environments separately for business and for personal use by switching users with the multiuser function. More specifically, in the tablet computer 1, the operating environments are set to permit only connection to wireless LAN[A] 2A when being used for business, and to prohibit connection to wireless LAN[A] 2A when being used for personal use. Thus, the tablet computer 1 includes a function of controlling permission and prohibition of connection to a network for individual users (including a basic user). This point will be hereinafter described in detail.

A management server 3 in FIG. 2 is a device configured to provide a client (information processing apparatus) connected to wireless LAN[A] 2A with various services, and is configured to manage network connection control information 301, which will be described later. The tablet computer 1 acquires the network connection control information 301 through wireless LAN[A] 2A from the management server 3.

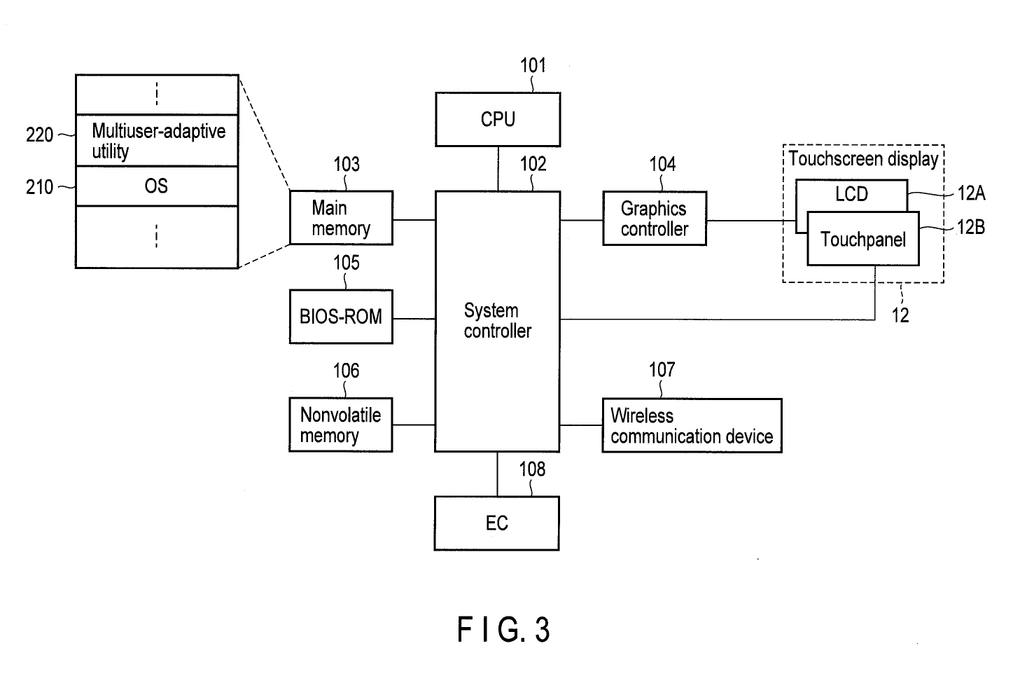

FIG. 3 is an exemplary view showing a system configuration of the tablet computer 1.

As shown in FIG. 3, the tablet computer 1 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor configured to control operations of various modules in the tablet computer 1. The CPU 101 is configured to load various pieces of software from the nonvolatile memory 106 into the main memory 103 and to execute them. These pieces of software include an operating system (OS) 210 and various application programs. The various application programs include a multiuser-adaptive utility program 220. The multiuser-adaptive utility program 220 is a program for providing a function of controlling permission and prohibition of connection to a network for individual users (including a basic user) in cooperation with the OS 210. Its basic principle will be described later.

In addition, the CPU 101 is also configured to execute a basic input/output system (BIOS) stored in the BIOS-ROM 105. The BIOS is a program for hardware control.

The system controller 102 is a device configured to connect a local bus of the CPU 101 with various components. A memory controller configured to perform access control over the main memory 103 is incorporated in the system controller 102. Besides, the system controller 102 includes a function of communicating with the graphics controller 104 via a serial bus of a PCI EXPRESS standard, etc.

The graphics controller 104 is a display controller configured to control an LCD 12A used as a display monitor of the tablet computer 1. A display signal generated by the graphics controller 104 is transmitted to the LCD 12A. The LCD 12A is configured to display a screen image based on the display signal. A touchpanel 12B is disposed on the LCD 12A. The touchpanel 12B is, for example, a capacitive pointing device for performing input on a screen of the LCD 12A. A touch position on the screen which a finger or a pen touches is detected by the touchpanel 12B.

The wireless communication device 107 is a device configured to perform wireless communication such as WLAN or 3G mobile communication. The EC 108 is a single-chip microcomputer comprising an embedded controller for power management. The EC 108 includes a function of turning the tablet computer 1 on or off in response to the user's operation of a power button.

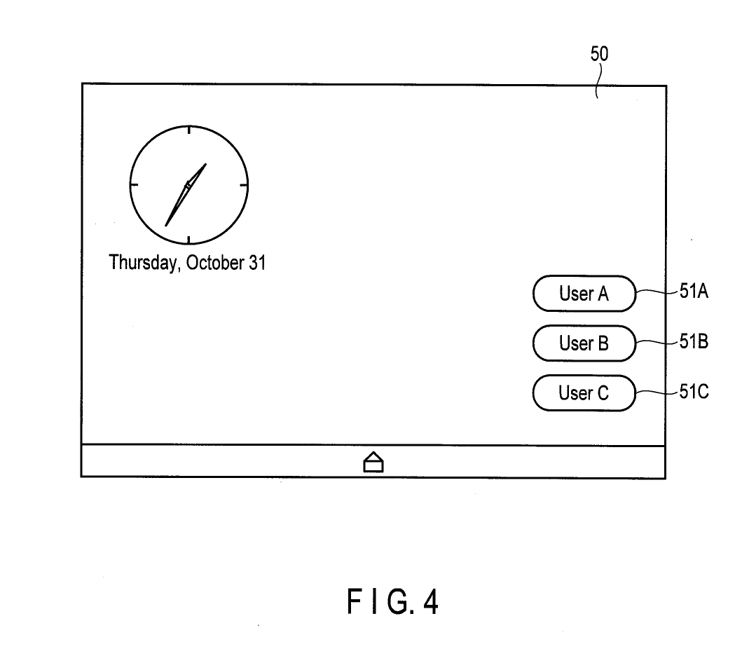

FIG. 4 is an exemplary view showing a login screen 50 displayed by the tablet computer 1.

In the tablet computer 1 including the multiuser function, three users A, B and C are set. Of these users, user C is a basic user. That is, user A and user B are additional users. Of two additional users A and B, user A is a user provided to be selected when the tablet computer 1 is used for business in the office. Here, user A is called a specific additional user, and user B, representing an additional user other than the specific additional user, is called another additional user. That is, user C, representing the basic user, and user B, representing the other additional user, are users selected when the tablet computer 1 is used for personal use outside the office, for example, at home. Thus, in the tablet computer 1, it is necessary that connection to wireless LAN[A] 2A be permitted and connection to wireless LAN[B] 2B be prohibited at the time of use by user A, and that, on the other hand, connection to wireless LAN[B] 2B be permitted and connection to wireless LAN[A] 2A be prohibited at the time of use by user B or user C. In particular, at the time of use by user A, it is required to restrict use of wireless LAN[A] 2A by an application program of user C without terminating an application program of user C, representing the basic user, or restricting its activation. The tablet computer 1 is configured to execute network connection control considering this point.

It should be noted that there are only one basic user and only one specific additional user, but there can be a plurality of other additional users. Thus, a users D, E, etc., can be further added as the other additional users. In the tablet computer 1, these are handled similarly to user B.

On the login screen, software buttons for selecting respective users set in the tablet computer 1 and logging in are displayed. Here, since three users A, B and C are set, a software button 51A for selecting user A and logging in, a software button 51B for selecting user B and logging in, a software button 51C for selecting user C and logging in are displayed as shown in FIG. 4. On the login screen 50, for example, the user can select user A, log in and use the tablet computer 1 by carrying out a predetermined touch operation (for example, a tap gesture or a swipe gesture) on the software button 51A.

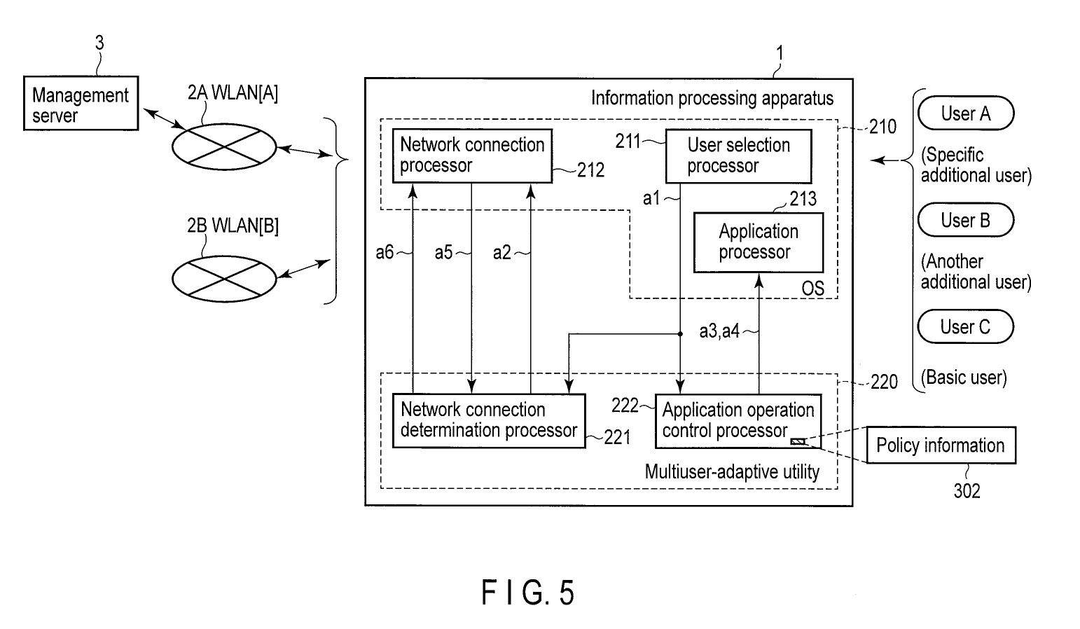

FIG. 5 is an exemplary view showing a functional block diagram associated with network connection control of the tablet computer 1.

As shown in FIG. 5, the tablet computer 1 includes a user selection processor 211, a network connection processor 212, an application processor 213, a network connection determination processor 221, and an application operation control processor 222. The user selection processor 211, the network connection processor 212 and the application processor 213 are each formed as a module of the OS 210. The network connection determination processor 221 and the application operation control processor 222 are each formed as a module of the multiuser-adaptive utility program 220.

The above described function of acquiring the network connection control information 301 through wireless LAN[A] 2A from the management server 3 is provided in the network connection determination processor 221. The network connection determination processor 221 includes also a function of, when the tablet computer 1 connects to wireless LAN[A] 2A, accessing the management server 3 and confirming whether the network connection control information 301 is updated or not, and if updated, acquiring the updated network connection control information 301 again from the management server 3, thereby maintaining the network connection control information 301 held in the tablet computer 1 up to date.

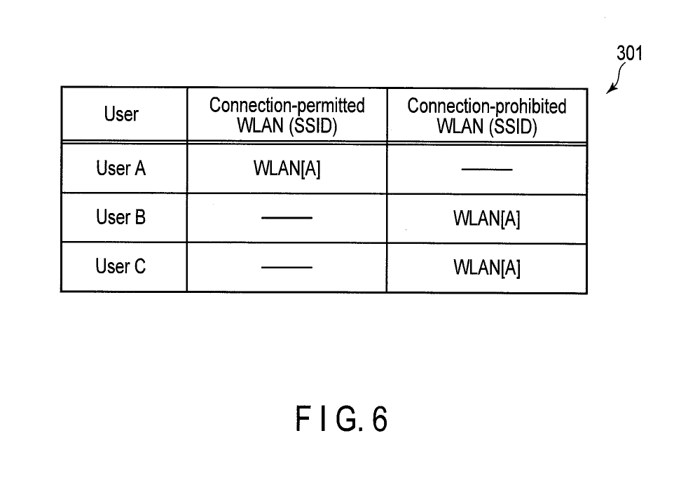

FIG. 6 shows an example of a structure of the network connection control information 301.

As shown in FIG. 6, first, the network connection control information 301 includes information on a network to which user A, representing the specific additional user, is permitted to connect. The information on a network is, for example, a service set identifier (SSID) of a wireless LAN. Second, the network connection control information 301 includes information on a network to which user B, representing the other additional user, and user C, representing the basic user, are prohibited from connecting. In this example, an SSID of wireless LAN[A] 2A, which is, for example, a corporate intranet, is included in the network connection control information 301 as information on a network to which user A (the specific additional user) is permitted to connect, and also as information on a network to which user B and user C (the basic user and the other additional user) are prohibited from connecting.

The user selection processor 211 is configured to display the login screen shown in FIG. 4, and to, in response to a user selection operation by a user on the login screen, transmit a user selection occurrence notification including information on a selected user to the network connection determination processor 221 and the application operation control processor 222 (a1 of FIG. 5). The information on a selected user included in the user selection occurrence notification includes information indicating any of the specific additional user, the other additional user and the basic user.

Now, it is assumed that the tablet computer 1 is connecting to at least one of wireless LAN[A] 2A and wireless LAN[B] 2B. Upon receiving a user selection occurrence notification from the user selection processor 211 under such a condition, the network connection determination processor 221 executes the following processing on the basis of information on a selected user included in the user selection occurrence notification and the network connection control information 301 shown in FIG. 6.

If the selected user is user A (the specific additional user), connection to wireless LAN[A] 2A is permitted. Thus, if the tablet computer 1 is connecting to wireless LAN[B] 2B (other than wireless LAN[A] 2A), the network connection determination processor 221 transmits a network disconnection request notification on wireless LAN[B] 2B to the network connection processor 212 (a2 of FIG. 5). The network connection processor 212 is a module configured to control connection and disconnection to networks including wireless LAN[A] 2A and wireless LAN[B] 2B. If the tablet computer 1 is connecting to wireless LAN[A] 2A, this connection is maintained.

Thereby, wireless LAN[B] 2B is prevented from being used by an application program of user A (when user A is selected).

Also, if the selected user is user B (the other additional user) or user C (the basic user), connection to wireless LAN[A] 2A is prohibited. Thus, if the tablet computer 1 is connecting to wireless LAN[A] 2A, the network connection determination processor 221 transmits a network disconnection request notification on wireless LAN[A] 2A to the network connection processor 212 (a2 of FIG. 5). If the tablet computer 1 is connecting to a network other than wireless LAN[A] 2A, that is, wireless LAN[B] 2B, this connection is maintained.

Thereby, wireless LAN[A] 2A is prevented from being used by an application program of user B or user C (when user B or user C is selected).

On the other hand, in parallel with the network connection determination processor 221, the application operation control processor 222, which is configured to receive a user selection occurrence notification from the user selection processor 211, executes the following processing on the basis of information on a selected user included in the user selection occurrence notification and policy information 302 held by itself. The policy information 302 indicates (1) terminating an application program of the other additional user and restricting its activation when the specific additional user is selected, (2) restricting network use by an application program of the basic user when the specific additional user is selected, and (3) terminating an application program of the specific additional user and restricting its activation when the other additional user or the basic user is selected. The policy information 302, for example, may be given as a parameter when the multiuser-adaptive utility program 220 is activated, or may be incorporated in the application operation control processor 222 in advance.

As is clear from the contents of the policy information 302, if the selected user is user A (the specific additional user), the application operation control processor 222, first, transmits a notification of requesting termination of an application program of user B (the other additional user) and restriction of its activation to the application processor 213 (a3 of FIG. 5). The application processor 213 is a module configured to control activation, termination, activation restriction and network use restriction of various application programs. At the time of receiving this notification, if there are any application programs of user B in operation, the application processor 213 terminates all of them. Also, from this time on, the application processor 213 restricts activation of an application program of user B (until a removal request of activation restriction is notified). If activation of an application program of user A is restricted (when user A is selected), the application operation control processor 222 transmits a notification of requesting removal of this restriction to the application processor 213.

Thereby, wireless LAN[A] 2A is prevented from being used by an application program of user B (when user A is selected).

Here, it should be noted that even if the selected user is user A (the specific additional user), the application operation control processor 222 does not request the application processor 213 to terminate an application program of user C (the basic user) and to restrict its activation. In other words, in the tablet computer 1, an application program of the basic user is not terminated and its activation is not restricted. That is, there is no risk that an application program of the basic user is terminated or its activation is restricted, and thus the operation of the tablet computer 1 is not guaranteed.

If the selected user is user A (the specific additional user), the application operation control processor 222, second, transmits a notification of requesting restriction of network use by an application program of user C (the basic user) to the application processor 213 (a4 of FIG. 5).

Thereby, wireless LAN[A] 2A is prevented from being used by an application program of user C (when user A is selected) in addition to user B described above.

If the selected user is user B (the other additional user) or user C (the basic user), the application operation control processor 222 transmits a notification of requesting termination of an application program of user A (the specific additional user) and restriction of its activation to the application processor 213 (a3 of FIG. 5). Upon receiving this notification, the application processor 213 terminates all application programs of user A in operation, and from this time on, restricts activation of an application program of user B (until a removal request of activation restriction is notified). If activation of an application program of user B is restricted and network use by an application program of user C is restricted (when user B or user C is selected), the application operation control processor 222 transmits a notification of requesting removal of these restrictions to the application processor 213.

Thereby, wireless LAN[B] 2B is prevented from being used by an application program of user A (when user B or user C is selected).

As described above, the tablet computer 1 can permit use of only a network which the specific additional user is permitted to use when being used by the specific additional user, and on the other hand, can prohibit use of a network which the specific additional user is permitted to use when being used by the basic user or the other additional user, without terminating an application program of the basic user or restricting its activation, by a combination of:

(1) disconnecting a network which the basic user or the other additional user is prohibited from using and which the specific additional user is permitted to use when the basic user or the other additional user is selected, and disconnecting a network other than a network which the specific additional user is permitted to use when the specific additional user is selected;

(2) terminating an application program of the specific additional user or restricting its activation when the basic user or the other additional user is selected, and terminating an application program of the other additional user or restricting its activation when the specific additional user is selected; and

(3) restricting network use by an application program of the basic user when the specific additional user is selected.

Incidentally, connection to a network can be started by an instruction from a user, or can be automatically started when an environment for network connection is ready. When starting connection to a network, the network connection processor 212 transmits a network connection start occurrence notification including information on a network to which connection is to be started to the network connection determination processor 221 (a5 of FIG. 5). The information associated with a network to which connection is to be started included in the network connection start occurrence notification includes, for example, an SSID of a wireless LAN.

Upon receiving a network connection start occurrence notification from the network connection processor 212, the network connection determination processor 221 executes the following processing on the basis of the information on a network to which connection is to be started included in the network connection start occurrence notification and the network connection control information 301 shown in FIG. 6.

At the time of use by user A (the specific additional user), if connection to wireless LAN[A] 2A is about to be started, the network connection determination processor 221 transmits a connection start permission notification to the network connection processor 212 (a6 of FIG. 5). Upon receiving this notification, the network connection processor 212 starts connection to wireless LAN[A] 2A. On the other hand, if connection to a network other than wireless LAN[A] 2A, i.e., wireless LAN[B] 2B, is about to be started, the network connection determination processor 221 transmits a connection start prohibition notification to the network connection processor 212 (a6 of FIG. 5). Upon receiving this notification, the network connection processor 212 cancels starting connection to wireless LAN[B] 2B.

At the time of use by user B (the other additional user) or user C (the basic user), if connection to wireless LAN[A] 2A is about to be started, the network connection determination processor 221 transmits a connection start prohibition notification to the network connection processor 212 (a6 of FIG. 5). Upon receiving this notification, the network connection processor 212 cancels starting connection to wireless LAN[A] 2A. On the other hand, if connection to a network other than wireless LAN[A] 2A, i.e., wireless LAN[B] 2B, is about to be started, the network connection determination processor 221 transmits a connection start permission notification to the network connection processor 212 (a6 of FIG. 5). Upon receiving this notification, the network connection processor 212 starts connection to wireless LAN[B] 2B.

Thereby, connection to wireless LAN[B] 2B when user A (the specific additional user) is selected is surely prevented, and connection to wireless LAN[A] 2A when user B (the other additional user) or user C (the basic user) is selected is surely prevented.

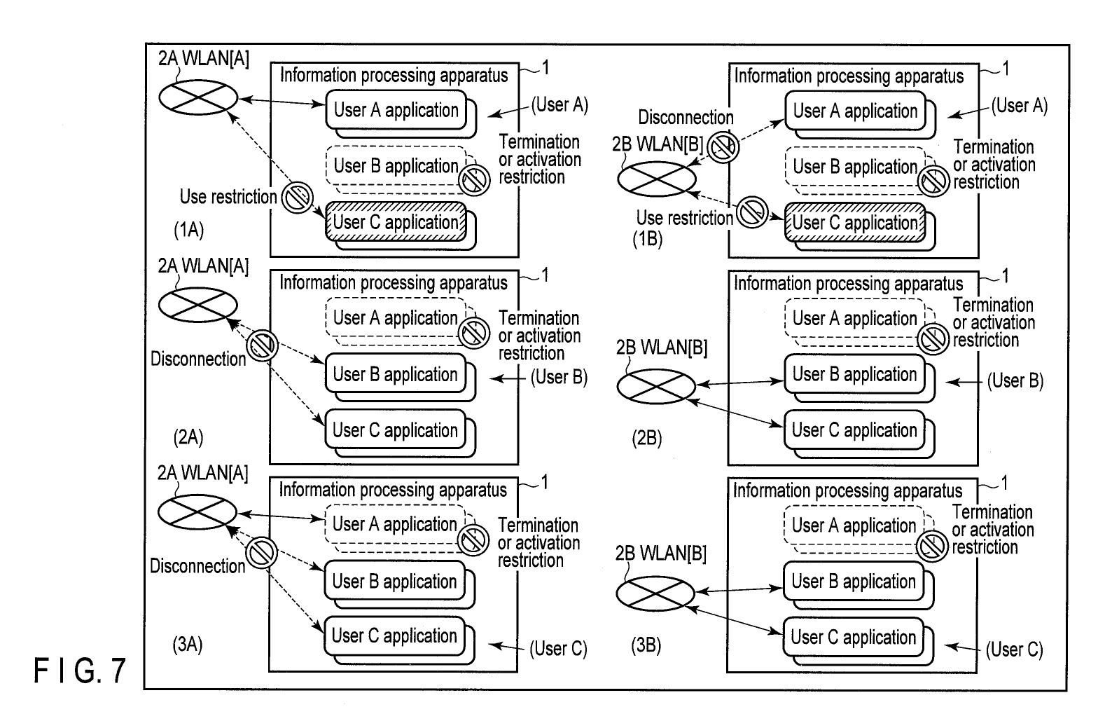

FIG. 7 shows an outline of network connection control by the tablet computer 1.

If user A (the specific additional user) is selected, connection to wireless LAN[B] 2B is cut, an application program of user B (the other additional user) is terminated or its activation is restricted, and network use of an application program of user C (the basic user) is restricted. Thus, use of wireless LAN[B] 2B by an application program of user A (the specific additional user), and use of wireless LAN[A] 2A by an application program of user B (the other additional user) or user C (the basic user) are prohibited ((1A) and (1B) of FIG. 7).

If user B (the other additional user) or user C (the basic user) is selected, connection to wireless LAN[A] 2A is cut, an application program of user A (the specific additional user) is terminated or its activation is restricted. Thus, use of wireless LAN[B] 2B by an application program of user A (the specific additional user), and use of wireless LAN[A] 2A by an application program of user B (the other additional user) or user C (the basic user) are prohibited ((2A), (2B), (3A) and (3B) of FIG. 7).

As shown in FIG. 7, when user A, representing the specific additional user, is selected, without terminating an application program of user C, representing the basic user, or restricting its activation, use of wireless LAN[A] 2A and wireless LAN[B] 2B by an application program of user C is restricted.

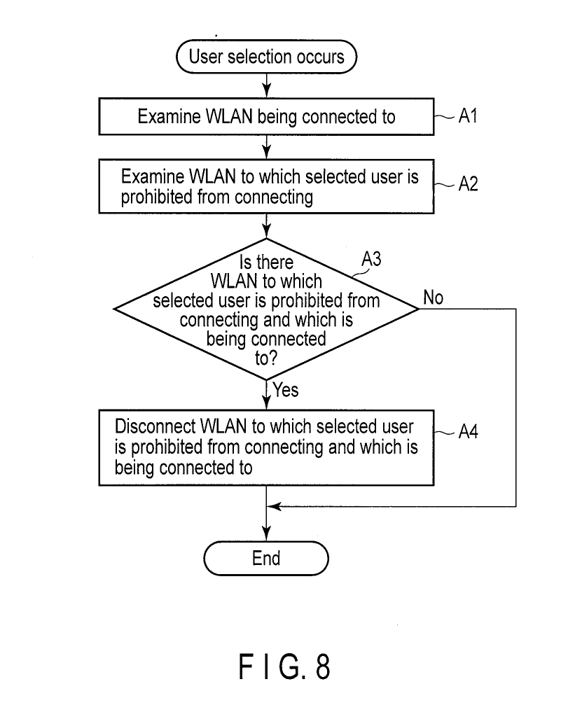

FIG. 8 is an exemplary first flowchart showing a procedure of network connection control executed by the information processing apparatus of the embodiment.

When any user logs in, the user selection processor 211 transmits a user selection occurrence notification to the network connection determination processor 221. Upon receiving this user selection occurrence notification, the network connection determination processor 221 examines a wireless LAN to which the tablet computer 1 is connecting (block A1). In addition, the network connection determination processor 221 examines a wireless LAN to which the selected user is prohibited from connecting (block A2).

The network connection determination processor 221 examines whether a wireless LAN to which the selected user is prohibited from connecting and to which the tablet computer 1 is connecting is present or not (block A3). If present (YES in block A3), the network connection determination processor 221 transmits a network disconnection request notification on the wireless LAN to the network connection processor 212 (block A4).

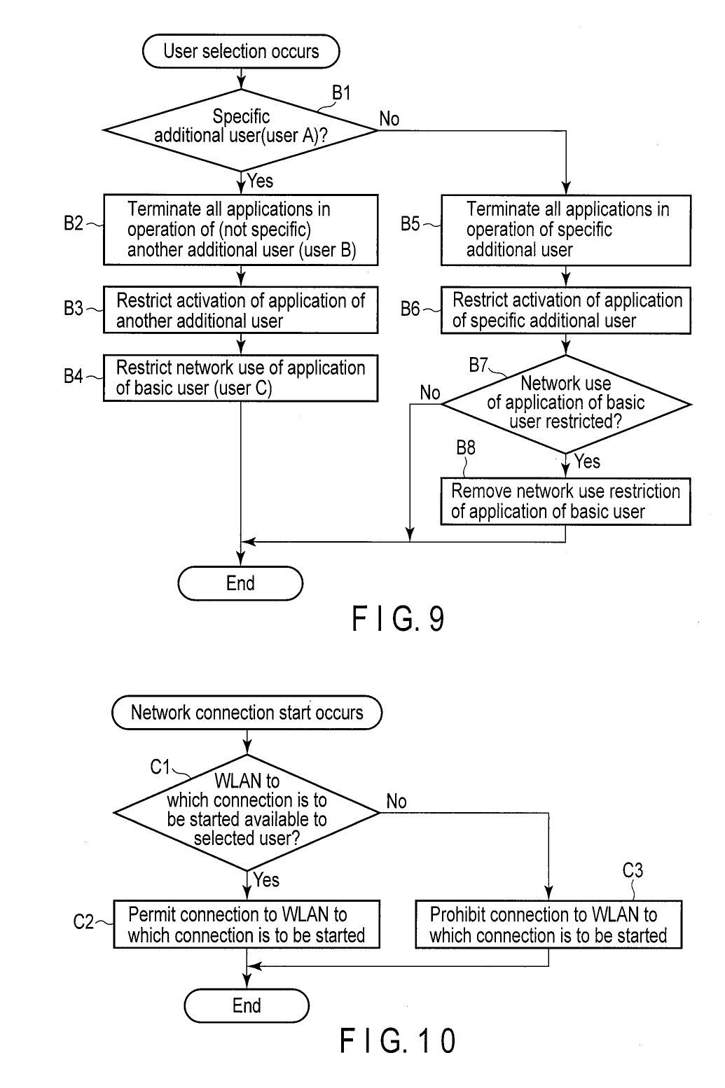

FIG. 9 is an exemplary second flowchart showing a procedure of network connection control executed by the information processing apparatus of the embodiment.

If any user logs in, the user selection processor 211 transmits a user selection occurrence notification also to the application operation control processor 222 in parallel with transmission to the network connection determination processor 221. Upon receiving this user selection occurrence notification, the application operation control processor 222 determines whether the selected user is the specific additional user or not (block B1). If it is the specific additional user (YES in block B1), the application operation control processor 222 transmits a notification of requesting termination of an application program of the other additional user and restriction of its activation to the application processor 213 (blocks B2 and B3). In addition, the application operation control processor 222 transmits a notification of requesting restriction of network use by an application program of the basic user to the application processor 213 (block B4).

On the other hand, if it is not the specific additional user (NO in block B1), that is, if it is the other additional user or the basic user, the application operation control processor 222 transmits a notification of requesting termination of an application program of the specific additional user and restriction of its activation to the application processor 213 (blocks B5 and B6). In addition, the application operation control processor 222 examines whether network use by an application program of the basic user is restricted or not (block B7), and if restricted (YES in block B7), transmits a notification of requesting its removal to the application processor 213 (block B8).

FIG. 10 is an exemplary third flowchart showing a procedure of network connection control executed by the information processing apparatus of the embodiment.

When connection to a network is started by, for example, an instruction by a user, etc., the network connection processor 212 transmits a network connection start occurrence notification to the network connection determination processor 221. Upon receiving this network connection start occurrence notification, the network connection determination processor 221 determines whether a network to which connection is to be started is a network available to the selected user or not (block C1). If available (YES in block C1), the network connection determination processor 221 transmits a connection start permission notification to the network connection processor 212 (block C2). On the other hand, if not available (NO in block C1), the network connection determination processor 221 transmits a connection start prohibition notification to the network connection processor 212 (block C3).

As described above, according to the tablet computer 1, permission and prohibition of connection to a network can be controlled for individual users (including the basic user) set by the multiuser function.

Various processes of the present embodiment can be implemented by a computer program. Thus, the same advantages as those of the present embodiment can be easily achieved simply by installing and executing the computer program on a normal computer through a computer-readable storage medium storing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus capable of a multiuser function, comprising:
a user selection processor configured to select one of a first user, a second user and a third user, the first user representing a basic user, the second user representing a specific additional user, the third user representing an additional user other than the specific additional user;
a network connection processor configured to connect to a network comprising a first network which the second user is permitted to use;
an application processor configured to activate, terminate, restrict activation of, and restrict network use by, an application program;
a first multiuser-adaptive controller configured to control the network connection processor to disconnect the first network when the first user or the third user is selected, and to disconnect a second network other than the first network when the second user is selected;
a second multiuser-adaptive controller configured to control the application processor to terminate a second application program of the second user or restrict activation of the second application program when the first user or the third user is selected, and to terminate a third application program of the third user or restrict activation of the third application program when the second user is selected; and
a third multiuser-adaptive controller configured to control the application processor to restrict network use by a first application program of the first user when the second user is selected.

2. The apparatus of claim 1, wherein the first multiuser-adaptive controller is configured to control the network connection processor to reject a connection request to the first network when the first user or the third user is selected, and to reject a connection request to the second network other than the first network when the second user is selected.

3. The apparatus of claim 1, wherein the second multiuser-adaptive controller is configured to control the application processor to remove activation restriction of the third application program when activation of the third application program is restricted when the first user or the third user is selected, and to remove activation restriction of the second application program when activation of the second application program is restricted when the second user is selected.

4. The apparatus of claim 1, wherein the third multiuser-adaptive controller is configured to control the application processor to remove restriction of network use by the first application program when network use by the first application program is restricted when the first user or the third user is selected.

5. The apparatus of claim 1, further comprising an acquisition controller configured to acquire control information associated with the first network which the first user and the third user are prohibited from using and the second network which the second user is permitted to use.

6. The apparatus of claim 5, wherein the acquisition controller is configured to acquire the control information from a management server connected through the first network.

7. The apparatus of claim 6, wherein the acquisition controller is configured to confirm whether the control information managed by the management server is updated or not when connecting to the first network, and to acquire updated control information when the control information is updated.

8. The apparatus of claim 5, wherein the control information comprises a service set identifier (SSID) of a wireless LAN.

9. A control method of an information processing apparatus capable of a multiuser function, the method comprising:
selecting one of a first user, a second user and a third user, the first user representing a basic user, the second user representing a specific additional user, the third user representing an additional user other than the specific additional user;
disconnecting a first network which the second user is permitted to use when the first user or the third user is selected, and disconnecting a second network other than the first network when the second user is selected;
terminating a second application program of the second user or restricting activation of the second application program when the first user or the third user is selected, and terminating a third application program of the third user or restricting activation of the third application program when the second user is selected; and
restricting network use by a first application program of the first user when the second user is selected.

10. A computer-readable, non-transitory storage medium having stored thereon a computer program which is executable by a computer capable of a multiuser function, the computer program controlling the computer to function as:
a user selection processor configured to select one of a first user, a second user and a third user, the first user representing a basic user, the second user representing a specific additional user, the third user representing an additional user other than the specific additional user;
a network connection processor configured to connect to a network comprising a first network which the second user is permitted to use;
an application processor configured to activate, terminate, restrict activation of, and restrict network use by, an application program;
a first multiuser-adaptive controller configured to control the network connection processor to disconnect the first network when the first user or the third user is selected, and to disconnect a second network other than the first network when the second user is selected;
a second multiuser-adaptive controller configured to control the application processor to terminate a second application program of the second user or restrict activation of the second application program when the first user or the third user is selected, and to terminate a third application program of the third user or restrict activation of the third application program when the second user is selected; and
a third multiuser-adaptive controller configured to control the application processor to restrict network use by a first application program of the first user when the second user is selected.
